(19) United States
(12) Patent Application Publication
(10) Pub. No.: US 2026/0194868 A1
(43) Pub. Date: Jul. 9, 2026

(54) DYNAMIC SELECTION OF APPROPRIATE MIX OF COOLANT AND LUBRICTION FOR METALWORKING

(71) Applicant: International Business Machines Corporation, Armonk, NY (US)

(72) Inventors: Sarbajit Kumar Rakshit, Kolkata (IN); Sudheesh S. Kairali, Kozhikode (IN); Binoy Thomas, Kozhikode (IN)

(21) Appl. No.: 19/008,807

(22) Filed: Jan. 3, 2025

(51) Int. Cl. G05B 13/02; B23Q 11/10; G06T 7/00

(52) U.S. Cl. CPC G05B 13/0265; B23Q 11/1061; G06T 7/0004

(57) ABSTRACT

A lubricant-coolant mixture selection method is provided for preventing thin-film lubricant rupture of a metalworking of a metallic surface. The lubricant-coolant mixture selection method includes measuring surface roughness of the metallic surface and generating data indicative of thin-film lubricant rupture conditions. The lubricant-coolant selection method also includes determining lubricant film thickness for the metalworking based on the surface roughness and the data, determining predictions of a chip formation pattern of the metalworking and where the chip formation pattern leads to chip impact on the metallic surface and determining a heat generation prediction of the metalworking from tooling specifications and operational parameters.

### BACKGROUND

The present disclosure generally relates to metalworking. More specifically, the present disclosure relates to a method and a system for a dynamic selection of an appropriate mix of coolant and lubrication for predicted rupturing of thin-film lubrication in metalworking applications.

Metalworking is the process of shaping and reshaping metals in order to create useful objects, parts, assemblies and large scale structures. Metalworking processes can be generally categorized into areas including, but not limited to, forming processes, cutting processes and joining processes. The forming processes tend to involve metal modification by deformation without material removal. Cutting processes are those in which material is brought to a specific geometry removal of excess material. Joining processes can include, for example, welding processes, brazing processes, riveting processes and mechanical fixings.

### SUMMARY

According to an aspect of the disclosure, a lubricant-coolant mixture selection method is provided for preventing thin-film lubricant rupture of a metalworking of a metallic surface. The lubricant-coolant mixture selection method includes measuring surface roughness of the metallic surface and generating data indicative of thin-film lubricant rupture conditions. The lubricant-coolant selection method also includes determining lubricant film thickness for the metalworking based on the surface roughness and the data, determining predictions of a chip formation pattern of the metalworking and where the chip formation pattern leads to chip impact on the metallic surface and determining a heat generation prediction of the metalworking from tooling specifications and operational parameters.

According to an aspect of the disclosure, a lubricant-coolant mixture selection and application method is provided for a metalworking of a metallic surface. The lubricant-coolant mixture selection and application method includes measuring surface roughness of the metallic surface and generating data indicative of thin-film lubricant rupture conditions. The lubricant-coolant mixture selection and application method also includes determining a lubricant film thickness for the metalworking based on the surface roughness and the data, determining predictions of a chip formation pattern of the metalworking and where the chip formation pattern leads to chip impact on the metallic surface, determining a heat generation prediction of the metalworking from tooling specifications and operational parameters and determining respective coolant and lubricant concentrations of a coolant-lubricant mixture of the metalworking from coolant and lubricant specifications. In addition, the lubricant-coolant mixture selection and application method includes operating measuring, imaging and tooling components of a system for executing the metalworking based on determining results to apply the coolant-lubricant mixture to the metallic surface for preventing thin-film lubricant rupture.

According to an aspect of the disclosure, a system for lubricant-coolant mixture selection and application for a metalworking of a metallic surface is provided. The system includes measuring, imaging and tooling components and a processor. The processor includes memory and is configured to generate data in the memory indicative of thin-film lubricant rupture conditions. The processor is also configured to operate the measuring, imaging and tooling components to measure surface roughness of the metallic surface and to determine a lubricant film thickness for the metalworking based on the surface roughness and the data, predictions of a chip formation pattern of the metalworking and where the chip formation pattern leads to chip impact on the metallic surface, a heat generation prediction of the metalworking from tooling specifications and operational parameters and respective coolant and lubricant concentrations of a coolant-lubricant mixture of the metalworking from coolant and lubricant specifications. In addition, the processor is configured to execute the metalworking based on determining results to apply the coolant-lubricant mixture to the metallic surface for preventing thin-film lubricant rupture.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the disclosure are apparent from the following detailed description taken in conjunction with the accompanying drawings in which:

FIG. 1 is a schematic diagram of a computing environment executing electrochemical machining (ECM) on a workpiece in accordance with one or more embodiments of the present invention;

FIG. 2 is a flow diagram illustrating a lubricant-coolant mixture selection and application method for preventing thin-film lubricant rupture of a metalworking of a metallic surface in accordance with one or more embodiments of the present invention;

FIG. 3 is a schematic diagram of a system for executing the lubricant-coolant mixture selection and application method of FIG. 3 in accordance with one or more embodiments of the present invention; and

FIG. 4 is a graphical illustration of the system of FIG. 3 in accordance with one or more embodiments of the present invention.

The diagrams depicted herein are illustrative. There can be many variations to the diagram or the operations described therein without departing from the spirit of the disclosure. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the described embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

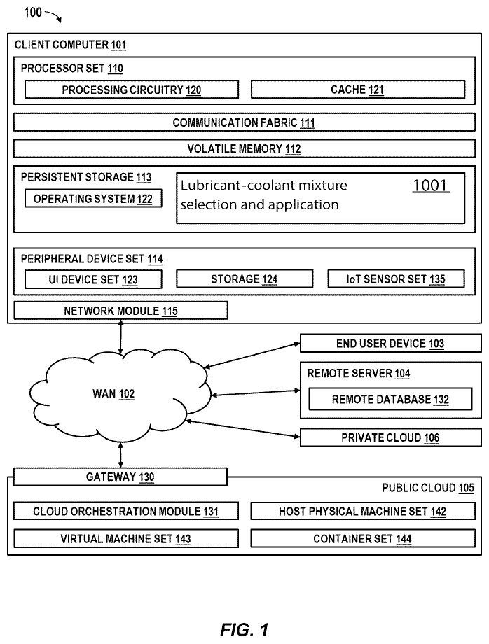

With reference to FIG. 1, a computer or computing device 100 that implements a computer-implemented method for lubricant-coolant mixture selection and application is provided in accordance with one or more embodiments of the present invention is provided. The computer or computing device 100 of FIG. 1 contains an example of an environment for the execution of at least some of the computer code involved in performing the inventive methods, such as the block 1001 of the computer-implemented method for lubricant-coolant mixture selection and application. In addition to the computer-implemented method for lubricant-coolant mixture selection and application of block 1001, the computer or computing device 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the computer-implemented method of block 1001, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

The computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of the computer-implemented method, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

The processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In the computer-implemented method, at least some of the instructions for performing the inventive methods may be stored in the block 1001 of the computer-implemented method in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the block 1001 of the computer-implemented method typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud

For the sake of brevity, conventional fabrication techniques may or may not be described in detail herein. Moreover, the various tasks and process steps described herein can be incorporated into a more comprehensive procedure or process having additional steps or functionality not described in detail herein. In particular, various steps in the manufacture of certain types of devices are well known and so, in the interest of brevity, many conventional steps will only be mentioned briefly herein or will be omitted entirely without providing the well-known process details.

Turning now to an overview of technologies that are more specifically relevant to aspects of the disclosure, metalworking chemical concentrates are designed to be used at a number of different concentrations. Each product and application will have an ideal concentration ratio for the metalworking fluid. The concentration will affect sump life, tool life and surface finish. Maintaining proper concentration is thus essential for efficient and trouble-free results from water-miscible cutting and grinding fluids and sump “trouble calls” are often directly or indirectly attributable to poor concentration control. Concentration control is difficult to achieve when the coolant is manually mixed in small batches and is virtually impossible to maintain when untrained operators mix coolant.

Cutting fluid is a type of coolant and lubricant designed specifically for metalworking processes, such as machining and stamping. There are various kinds of cutting fluids including, but not limited to, oils, oil-water emulsions, pastes, gels, aerosols (mists) and air or other gases. Cutting fluids can be made from petroleum distillates, animal fats, plant oils, water and air or other raw ingredients. Depending on context and on which type of cutting fluid is being considered, it may be referred to as cutting fluid, cutting oil, cutting compound, coolant or lubricant. Most metalworking and machining processes can benefit from the use of cutting fluid, depending on workpiece material. Common exceptions to this are cast iron and brass, which may be machined dry (though this is not true of all brasses, and any machining of brass will likely benefit from the presence of a cutting fluid).

Properties that are often sought after in a good cutting fluid are the ability to keep the workpiece at a stable temperature (critical when working to close tolerances) where very warm is acceptable but extremely hot or alternating hot-and-cold are typically to be avoided, the ability to maximize the life of the cutting tip by lubricating the working edge and reducing tip welding, the ability to ensure safety for the people handling it (toxicity, bacteria, fungi) and for the environment upon disposal and the ability to prevent rust on machine parts and cutters.

Typically, metal working fluids have a dilution range of between 5:1 and 25:1. Grinding is best with a ratio of 20-25:1, machining 5-15:1 (depending on the metal and which lubricant is used) and sawing 5-15:1 (depending on the metal, and which lubricant).

Film lubrication, also known as thin-film lubrication, is a mechanism used to reduce friction and wear between two surfaces in relative motion by introducing a thin layer of lubricating fluid between them. This lubricating film separates the surfaces, preventing direct metal-to-metal contact and allowing for smoother movement. The lubricant film reduces friction and wear and helps dissipate heat generated during sliding or rolling processes. This type of lubrication can be crucial in various mechanical systems to enhance efficiency, extend the lifespan of components and prevent excessive heat buildup that can lead to premature failure. Film lubrication is commonly utilized in applications such as internal combustion engines, gears, bearings and metal cutting processes. In metal cutting, for instance, a thin-film of lubricating fluid is applied between the cutting tool and the workpiece to minimize friction and heat generation, improving cutting efficiency and tool life.

While thin-film lubrication offers various benefits in metal cutting, there are certain situations where it can break down or cause problems. These include high temperature situations. In high-speed or high-temperature machining operations, the elevated temperatures can cause the thin lubricating film to degrade or evaporate quickly. This can result in reduced lubrication effectiveness, increased friction and accelerated tool wear. In severe cutting conditions, when subjected to heavy cutting loads or aggressive machining conditions, a thin lubricating film may not be able to withstand the extreme forces and pressures. This can lead to film rupture and direct metal-to-metal contact, causing excessive wear and heat generation. If a selected lubricant or coating material does not have suitable properties for the specific cutting application, such as thermal stability, chemical compatibility or viscosity, the thin-film lubrication may break down prematurely, leading to reduced performance. If a lubricant application system is not properly designed or maintained, it can result in uneven or insufficient lubricant delivery to the cutting zone. Inadequate lubrication coverage can lead to localized friction and wear. In metal cutting, chips are formed as material is removed from the workpiece. These chips can become trapped between the cutting tool and workpiece, disrupting the thin-film lubrication and causing increased friction, heat and potential tool damage. Contaminants such as dust, debris, or coolant residues can interfere with the thin-film lubrication by disrupting its integrity or reducing its effectiveness. This can result in uneven lubricant distribution or compromised lubrication performance. Some lubricants may degrade chemically when exposed to the cutting environment, leading to changes in viscosity, loss of lubricating properties or the formation of undesirable byproducts that can interfere with the cutting process. Certain lubricants or coatings may not be compatible with the specific materials being machined, leading to chemical reactions or adhesion issues that compromise lubrication effectiveness.

Measuring thin-film lubrication involves assessing the thickness and effectiveness of the lubricant layer between two moving surfaces. Various techniques and instruments can be employed to quantify the lubricant film thickness and its performance. These include, but are not limited to, optical interferometry, ultrasonic measurement, electrical conductivity measurement and capacitance sensing. Optical interferometry uses light interference patterns to determine the thickness of the lubricant film. It offers high precision and is widely used for measuring thin-films in various applications. Ultrasonic measurement methods employ high-frequency sound waves to estimate the lubricant film thickness. Changes in sound wave propagation time can be correlated with variations in film thickness. Lubricants containing conductivity-altering additives can be examined using electrical conductivity measurements. Changes in conductivity reflect changes in the lubricant film thickness. Capacitance sensors measure changes in capacitance between surfaces due to the presence of a lubricant film. The resulting capacitance changes are indicative of the film thickness.

It is therefore apparent that coolants and lubricants play distinct yet complementary roles in metal cutting processes. Coolants, often referred to as cutting fluids, primarily focus on dissipating heat generated during cutting operations. They help maintain the temperature of the cutting tool and workpiece, preventing overheating that can lead to tool wear, thermal cracking and dimensional inaccuracies. Coolants also aid in chip evacuation by flushing away chips from the cutting zone. Lubricants are designed to reduce friction and wear between the cutting tool and workpiece surfaces. They form a protective layer, often referred to as a thin-film lubrication, that prevents direct metal-to-metal contact. This minimizes tool wear, lowers cutting forces and enhances surface finish. Lubricants are particularly useful in situations where high cutting speeds, heavy loads or challenging materials are involved. In practice, the choice between coolant and lubricant depends on the specific machining operation, material being cut, cutting speed and other process parameters. Some applications might benefit from a combination of both, where the coolant helps dissipate heat and the lubricant reduces friction and wear. Balancing the usage of coolants and lubricants can lead to improved machining efficiency, longer tool life and better surface quality. Meanwhile, it is also apparent that excess use of coolant and lubricant during metal cutting can lead to various problems that affect both the machining process and environmental considerations. Some of the notable issues include, but are not limited to, cost inefficiency, environmental impact, cleanliness and safety, machining quality issues, heat dissipation problems, chip management, health and safety concerns and machine maintenance.

To address these issues, it is often important to adopt a balanced approach to coolant and lubricant use during metal cutting. Considering can be given to specific machining requirements, the material being cut, the tooling used and the cutting conditions to determine the optimal amount of fluid required. Consideration can also be given to regularly monitoring and adjusting fluid usage, providing appropriate training to operators and implementing best practices for coolant and lubricant management to ensure efficient and environmentally responsible metal cutting operations. If thin-film lubrication breaks down or becomes insufficient, problems such as increased friction, heat generation and surface-to-surface contact can occur. This may lead to accelerated wear, elevated temperatures, component failure and reduced overall efficiency of the machinery or mechanical system where the lubrication is applied. Therefore, a method and a system are needed by which proper levels of lubrication and coolant are maintained so that rupture of thin-film lubrication can be prevented with optimum usage of lubricant.

Turning now to an overview of the aspects of the disclosure, one or more embodiments of the disclosure address the above-described shortcomings of the prior art by providing an analysis of metal surface roughness during metal cutting to determine if thin-film lubrication is adequate utilizing historical learning to optimize a lubricant-coolant mix ensuring prevention of metal-to-metal contact and heat dissipation, an assessment of material and tool specifications during metal cutting that measures real-time operational parameters to determine an optimal lubrication-coolant mix and that identifies target areas for thin-film lubrication application to prevent rupture and to dissipate heat effectively during cutting process, an analysis of chip formation patterns that can predict chip progression impact on thin-film lubrication integrity and that utilizes robotic an arm/chip breaking system to prevent lubrication rupture by removing or breaking chips as needed, an analysis and measurement of heat generation during metal cutting based on material, cutting speed and tooling that determines an optimal coolant-lubricant mixing ratio for cost-effective cutting and for maintaining thin-film lubrication integrity to prevent rupture, a performance of real-time lubricant-coolant mixing based on estimated heat and cutting operations that maximizes cutting effectiveness by dynamically adjusting mixture ratios to optimize performance and an integration of robotic applications for dynamic coolant-lubricant mixture to apply required mixing at targets areas prone to lubrication rupture and to ensure efficient metal cutting while optimizing coolant-lubricant consumption.

That is, a method is provided that assesses metal surface roughness during metalworking to ensure adequate lubrication with heat dissipation. The method optimizes lubricant-coolant mix based on historical data preventing metal-to-metal contact and heat buildup. Real-time analysis adjusts mix ratios and applies the lubricant-cooling mix at target areas preventing rupture and dissipating heat. Robotic application ensures precise mixture to enhance cutting efficiency while conserving coolant-lubricant.

Turning now to an overview of the aspects of the disclosure, one or more embodiments of the disclosure address the above-described shortcomings of the prior art by providing a lubricant-coolant mixture selection method for preventing thin-film lubricant rupture of a metalworking of a metallic surface. The method includes measuring surface roughness of the metallic surface and generating data indicative of thin-film lubricant rupture conditions. The method also includes determining lubricant film thickness for the metalworking based on the surface roughness and the data, predictions of a chip formation pattern of the metalworking and where the chip formation pattern leads to chip impact on the metallic surface, a heat generation prediction of the metalworking from tooling specifications and operational parameters and respective coolant and lubricant concentrations of a coolant-lubricant mixture of the metalworking from coolant and lubricant specifications.

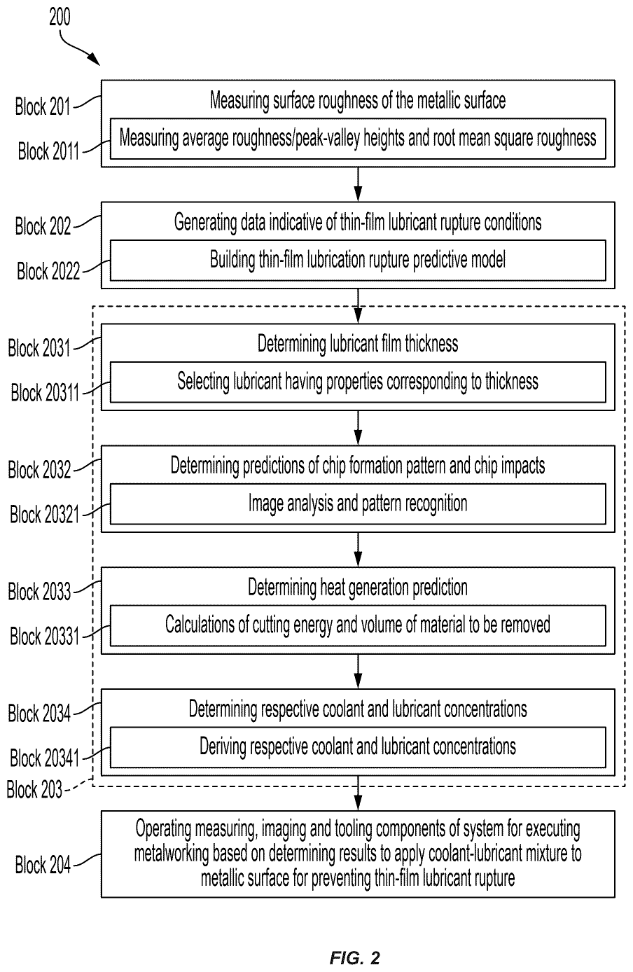

With reference to FIG. 2, a lubricant-coolant mixture selection and application method 200 is provided for a metalworking of a metallic surface. As shown in FIG. 2, the method 200 includes measuring surface roughness of the metallic surface (block 201), such as by measuring average roughness, average peak-valley heights and root mean square roughness (block 2011), and generating data indicative of thin-film lubricant rupture conditions (block 202) using machine learning to build a thin-film lubrication rupture predictive model (block 2021). In addition, the method 200 includes multiple determining operations (block 203). These include determining a lubricant film thickness for the metalworking based on the surface roughness and the data (block 2031) and selecting a lubricant having viscosity, density and pressure-viscosity properties corresponding to the thickness (block 20311), determining predictions of a chip formation pattern of the metalworking and where the chip formation pattern leads to chip impact on the metallic surface (block 2032) by image analysis and pattern recognition (block 20321), determining a heat generation prediction of the metalworking from tooling specifications and operational parameters (block 2033) based on calculations of a cutting energy and a volume of material to be removed of the metalworking (block 20331) and determining respective coolant and lubricant concentrations of a coolant-lubricant mixture of the metalworking from coolant and lubricant specifications (block 2034) by deriving the respective coolant and lubricant concentrations from suggested mixing ratios (block 20341). The method 200 further includes operating measuring, imaging and tooling components of a system for executing the metalworking based on determining results to apply the coolant-lubricant mixture to the metallic surface for preventing thin-film lubricant rupture (block 204).

In accordance with embodiments, the tooling components can include a coolant-lubricant dispenser, a mixing chamber upstream from the coolant-lubricant dispenser, such as a robotic dispenser, a coolant tank, a first control valve interposed between the coolant tank and the mixing chamber, a lubricant tank and a second control valve interposed between the lubricant tank and the mixing chamber. In these or other cases, the operating of the tooling components of block 204 can include operating each of the first and second control valves (block 2041) to open and close in a manner to produce the coolant-lubricant mixture in the mixing chamber with optimal respective concentrations of the coolant and the lubricant. In accordance with further embodiments, the measuring components can include robotic surface roughness measuring tools to generate profiles of the metallic surface, the imaging components can include robotic imaging hardware to image the metalworking for support of the determining of the predictions of the chip formation pattern and where the chip formation pattern leads to chip impact on the metallic surface and the tooling components can include robotic metalworking tools. In these or other cases, the robotic surface roughness measuring tools, the robotic imaging hardware, the robotic metalworking tools and the robotic dispenser can be automatically and autonomously movable relative to the metallic surface.

For the measuring of the surface roughness of the metallic surface of block 201, an instrument like a profilometer can be attached on a stable surface near the metallic surface. A determination of where the metalworking is to be performed will be made and an additional determination of where surface friction will occur on the metallic surface. A stylus of the profilometer can be gently brought into contact with the metallic surface (or a light beam-based non-touch system can also be used for measuring the surface roughness). As the stylus moves, or with non-touch light-based measurement system, data points representing height variations of the metallic surface are generated. These data points are collected and recorded as collected data, which can be used to generate surface profile graphs of the metallic surface that illustrate vertical deviations of the metallic surface from respective mean lines. Various roughness parameters can be calculated from the collected data, providing quantitative measurements of the surface roughness. Common parameters include, but are not limited to, average roughness (Ra), average maximum peak-to-valley height (Rz), root mean square roughness Rq), etc. It is to be understood that the surface roughness can change dynamically as the metalworking proceeds. Therefore, surface roughness measurements might be taken at various stages of the metalworking to capture different roughness characteristics.

For the generating of the data indicative of thin-film lubricant rupture conditions of block 202, a historical knowledge corpus can be generated to detect instances of when thin-film lubrication might rupture during the metalworking by collecting and analyzing data from past metalworking operations. Historical data could include information about the metallic surface materials, metalworking parameters such as speed, feed rate, depth of cut, etc., lubrication methods and properties, tool specifications and surface finish measurements. Observations related to the thin-film lubrication including, but not limited to, where lubrication might have failed, such as surface scoring, increased tool wear, reduced cutting quality or reports of issues from operators or quality control personnel can be made. Each historical metalworking instances can be categorized into groups: instances where thin-film lubrication appeared to rupture (failure cases) and instances where lubrication seemed to function properly (success cases). Scenarios that can impact thin-film lubrication performance can be identified and can include, for example, surface roughness, temperature, pressure, cutting forces, lubricant viscosity and any other measurable factors. Machine learning techniques can be used to build a predictive model using decision trees, random forests, support vector machines and/or neural networks. Models can be trained using historical data, where the features act as input variables and labels indicate whether lubrication rupture occurred. Based on created models, real-time or near-real-time metalworking can be monitored to predict a likelihood of thin-film lubrication rupture. Appropriate triggering actions can be provided for when the models predict a high likelihood of lubrication rupture such as by applying lubricant in a proactive manner at a target location.

For the determining of the lubricant film thickness of block 2031, it is to be understood that the surface roughness of the tooling components and the metallic surface can influence an amount of lubrication required to ensure effective separation. A common approach to this problem can be to calculate the lubrication film thickness using empirical formulas or models that consider the surface roughness. One such model is the Reynolds Equation for thin film lubrication.

$$h = \frac{k \text{?}}{6}$$

$$\text{?} \text{indicates text missing or illegible when filed}$$

Where:
h is the re lubrication f
k is a constant depending on lubricant properties.
R_{α} is the arithmetic mean roughness of the surfaces.

Based on available types of lubricant, a lubricant will be selected with appropriate viscosity and properties that can create the calculated film thickness. Lubricant properties like viscosity, density and pressure-viscosity coefficient play a crucial role in determining the film thickness. The selected lubricant will be supplied to the tooling components and the metallic surface before initiating the metalworking and while the metalworking progresses. This can be done through various methods such as spraying, dipping or using a lubrication system integrated with the cutting process (see below). During the metalworking, lubrication effectiveness can be monitored and adjusted. In some cases, real-time monitoring systems can provide feedback on the lubrication film's stability and thickness. Also, while the metalworking is in progress, results in terms of surface quality, cutting efficiency and wear on the tooling components and metallic surface can be evaluated and lubrication adjustments can be made.

For the determining of predictions of the chip formation pattern and where the chip formation pattern leads to chip impact on the metallic surface of block 2032, visual and thermal cameras or any other imaging system can be used to record the metalworking. These can be positioned to capture the metalworking or cutting zone, a metalworking or cutting tool and the metallic surface. Multiple metalworking operations can be considered with variations in parameters (cutting speed, feed rate, depth of cut, etc.), tool geometry, material properties and lubrication conditions. This will help capture a range of chip formation patterns. A high-speed camera or imaging system can be used to capture the metalworking at a high frame rate to provide more detailed insights into chip formation dynamics. Recorded videos or images will be analyzed to track chip formation processes. Image processing techniques can help extract information about chip shape, size, trajectory and contact points on the metallic surface. Image analysis can be performed for determining for example chip length, width, thickness, curvature and orientation. These features can provide valuable information about the chip formation pattern. Pattern recognition algorithms, such as edge detection, contour analysis or machine learning techniques can be performed to identify chip shapes and trajectories in each recorded video frame. The pattern recognition will be able to identify any point and how the point on the chip is moving. Based on the identified chip trajectories, determinations can be made as where chips are likely to touch the metallic surface. This could involve mapping chip paths onto a coordinate system and identifying the points of contact. Observed chip formation patterns and touch points can be compared with established theories or models of chip formation. This validation step can ensure that observations align with existing knowledge. A thermal camera feed can be used to identify touch points based on heat generation patterns and properties of lubricants to identify whether the generated temperatures can make the lubricant burn or foul. A real-time imaging system can be used to capture metalworking with the live video feed being processed using same or similar image analysis techniques to monitor chip formation in real time.

For the determining of the heat generation prediction of block 2033, sensors, cameras and other imaging systems can be used to collect information about the metallic surface material, including its thermal conductivity, specific heat capacity and other relevant thermal properties. Tooling specifications, including details like tool material, geometry, coating and a number of cutting edges, can be considered. Operational parameters, such as cutting speed, feed rate and depth of cut, that will be employed during the metalworking can be considered along with material properties and metalworking or cutting parameters to calculate a specific cutting energy (energy required to remove a unit volume of material). This can be done using the following formula:

$${U}_{c} = ( F \cdot V ) / A$$

Where:
U_{c} is the specific cutting energy.
F is the cutting force.
V is the cutting speed.
A is the cross-sectional area of the chip.

The heat generated during the metalworking can be calculated using the specific cutting energy and the volume of material removed. The heat generated can be approximated using the equation:

$$Q = {U}_{c} \cdot {V}_{m}$$

Where:
Q is the heat generated
U_{c} is the specific cutting energy.
Vₘ is the volume of material removed per unit time.

Computational modeling and simulation tools, such as Finite Element Analysis (FEA) or Computational Fluid Dynamics (CFD) software, can be used to create an accurate prediction of heat generation. These tools can account for complex factors such as temperature distribution, material behavior and chip formation.

For the determining of the respective coolant and lubricant concentrations of the coolant-lubricant mixture of block 2034, specifications of coolants and lubricants can be analyzed to partially determine appropriate mixing ratios for optimal lubrication while considering factors such as viscosity, lubricity, material properties and metalworking or cutting conditions. Detailed information about the properties of coolants and lubricants to be used can be considered. These properties can include viscosity, lubricity, thermal conductivity, chemical composition and any additives present. Properties of the metallic surface and the tooling can also be considered as different materials may require varying levels of lubrication to ensure effective chip evacuation and prevent tool wear. In addition, operational parameters such as cutting speed, feed rate and depth of cut can be considered as these influence heat generation and friction during the metalworking thus impacting lubrication requirements.

Based on material properties and operational conditions, desired outcomes of lubrication, such as reducing heat generation, minimizing tool wear, achieving a smoother surface finish and preventing chip adhesion can be determined. Manufacture-specified parameters of coolants and lubricants will have guidelines and recommendations for different operations. These guidelines may include suggested mixing ratios based on specific materials and conditions. Historical detail about different mixing ratios and compatibility of coolant and lubricant mixtures can also be considered along with performance metrics such as tool life, surface roughness, cutting forces and chip morphology to assess the impact of varying mixing ratios on the machining process.

For the operating of the measuring, imaging and tooling components of the system for executing the metalworking based on determining results to apply the coolant-lubricant mixture to the metallic surface for preventing thin-film lubricant rupture of block 204, the analyzed data will be used to identify when the thin-film lubricant might rupture based on the metalworking and material parameters, to identify when chip formation patterns and chip impacts and to identify heat generation issues to inform a control of the flow of coolant and the flow of lubricant.

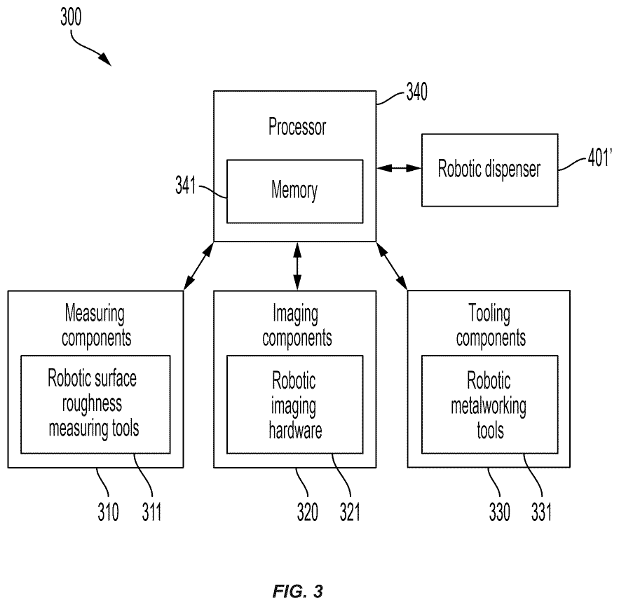

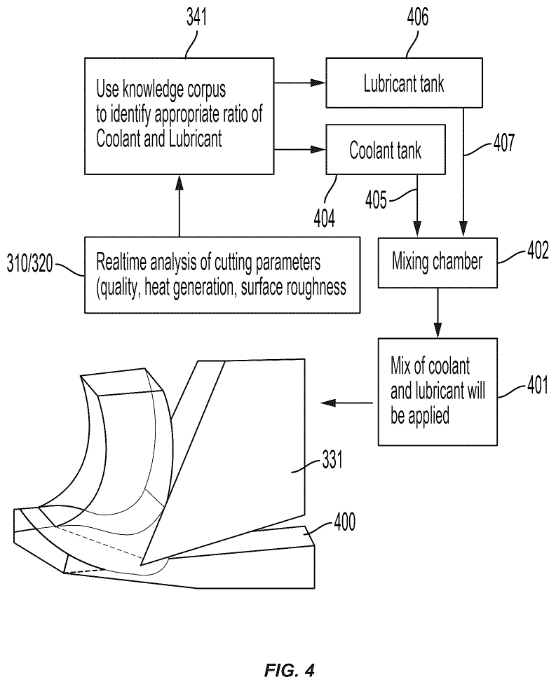

With reference to FIG. 3, a system 300 is provided for lubricant-coolant mixture selection and application for a metalworking of the metallic surface 400 (see FIG. 4). As shown in FIG. 3, the system 300 includes measuring components 310, imaging components 320 and tooling components 330 as well as a processor 340. The processor 340 includes memory 341 and is configured to generate data in the memory 341 that is indicative of thin-film lubricant rupture conditions. The processor 340 is further configured to operate the measuring components 310, the imaging components 320 and the tooling components 330 to measure surface roughness of the metallic surface 400, to determine a lubricant film thickness for the metalworking based on the surface roughness and the data, predictions of a chip formation pattern of the metalworking and where the chip formation pattern leads to chip impact on the metallic surface 400, a heat generation prediction of the metalworking from tooling specifications and operational parameters and respective coolant and lubricant concentrations of a coolant-lubricant mixture of the metalworking from coolant and lubricant specifications. The processor 340 is further configured to execute the metalworking based on determining results to apply the coolant-lubricant mixture to the metallic surface 400 for preventing thin-film lubricant rupture.

With continued reference to FIG. 3 and with reference to FIG. 4, the tooling components 330 can include a coolant-lubricant dispenser 401, a mixing chamber 402 upstream from the coolant-lubricant dispenser 401, a coolant tank 404, a first control valve 405 interposed between the coolant tank 404 and the mixing chamber 402, a lubricant tank 406 and a second control valve 407 interposed between the lubricant tank 406 and the mixing chamber 402. The operating of the tooling components 330 by the processor 340 can include independently operating each of the first control valve 405 and the second control valve 407.

With continued reference to FIGS. 3 and 4, the measuring components 310 can include robotic surface roughness measuring tools 311 to generate profiles of the metallic surface 400, the imaging components 320 can include robotic imaging hardware 321 to image the metalworking for supporting determining the predictions of the chip formation pattern and where the chip formation pattern leads to chip impact on the metallic surface 400, the tooling components 330 can further include robotic metalworking tools 331 and the dispenser 403 can include a robotic dispenser 401′. In these or other cases, the robotic surface roughness measuring tools 311, the robotic imaging hardware 321, the robotic metalworking tools 331 and the robotic dispenser 401′ can be automatically and autonomously movable relative to the metallic surface 400.

Various embodiments of the present disclosure are described herein with reference to the related drawings. Alternative embodiments can be devised without departing from the scope of this disclosure. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

The phrase “selective to,” such as, for example, “a first element selective to a second element,” means that the first element can be etched and the second element can act as an etch stop.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to semiconductor device and integrated circuit (IC) fabrication may or may not be described in detail herein. By way of background, however, a more general description of the semiconductor device fabrication processes that can be utilized in implementing one or more embodiments of the present disclosure will now be provided. Although specific fabrication operations used in implementing one or more embodiments of the present disclosure can be individually known, the described combination of operations and/or resulting structures of the present disclosure are unique. Thus, the unique combination of the operations described in connection with the fabrication of a semiconductor device according to the present disclosure utilize a variety of individually known physical and chemical processes performed on a semiconductor (e.g., silicon) substrate, some of which are described in the immediately following paragraphs.

In general, the various processes used to form a micro-chip that will be packaged into an IC fall into four general categories, namely, film deposition, removal/etching, semiconductor doping and patterning/lithography. Deposition is any process that grows, coats, or otherwise transfers a material onto the wafer. Available technologies include physical vapor deposition (PVD), chemical vapor deposition (CVD), electrochemical deposition (ECD), molecular beam epitaxy (MBE) and more recently, atomic layer deposition (ALD) among others. Removal/etching is any process that removes material from the wafer. Examples include etch processes (either wet or dry), and chemical-mechanical planarization (CMP), and the like. Semiconductor doping is the modification of electrical properties by doping, for example, transistor sources and drains, generally by diffusion and/or by ion implantation. These doping processes are followed by furnace annealing or by rapid thermal annealing (RTA). Annealing serves to activate the implanted dopants. Films of both conductors (e.g., poly-silicon, aluminum, copper, etc.) and insulators (e.g., various forms of silicon dioxide, silicon nitride, etc.) are used to connect and isolate transistors and their components. Selective doping of various regions of the semiconductor substrate allows the conductivity of the substrate to be changed with the application of voltage. By creating structures of these various components, millions of transistors can be built and wired together to form the complex circuitry of a modern microelectronic device. Semiconductor lithography is the formation of three-dimensional relief images or patterns on the semiconductor substrate for subsequent transfer of the pattern to the substrate. In semiconductor lithography, the patterns are formed by a light sensitive polymer called a photo-resist. To build the complex structures that make up a transistor and the many wires that connect the millions of transistors of a circuit, lithography and etch pattern transfer steps are repeated multiple times. Each pattern being printed on the wafer is aligned to the previously formed patterns and slowly the conductors, insulators and selectively doped regions are built up to form the final device.

The flowchart and block diagrams in the Figures illustrate possible implementations of fabrication and/or operation methods according to various embodiments of the present disclosure. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The descriptions of the various embodiments of the present disclosure have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A lubricant-coolant mixture selection method for preventing thin-film lubricant rupture of a metalworking of a metallic surface, comprising:
measuring surface roughness of the metallic surface;
generating data indicative of thin-film lubricant rupture conditions; and
determining:
lubricant film thickness for the metalworking based on the surface roughness and the data,
predictions of a chip formation pattern of the metalworking and where the chip formation pattern leads to chip impact on the metallic surface,
a heat generation prediction of the metalworking from tooling specifications and operational parameters, and
respective coolant and lubricant concentrations of a coolant-lubricant mixture of the metalworking from coolant and lubricant specifications.

2. The lubricant-coolant mixture selection method according to claim 1, wherein the measuring of the surface roughness comprises measuring average roughness, average peak-valley heights and root mean square roughness.

3. The lubricant-coolant mixture selection method according to claim 1, wherein the generating of the data comprises using machine learning to build a thin-film lubrication rupture predictive model.

4. The lubricant-coolant mixture selection method according to claim 1, wherein the determining of the lubricant film thickness comprises selecting a lubricant having viscosity, density and pressure-viscosity properties corresponding to the thickness.

5. The lubricant-coolant mixture selection method according to claim 1, wherein the determining of the predictions of the chip formation pattern and where the chip formation pattern leads to chip impact on the metallic surface comprises image analysis and pattern recognition.

6. The lubricant-coolant mixture selection method according to claim 1, wherein the determining of the heat generation prediction is based on calculations of a cutting energy and a volume of material to be removed of the metalworking.

7. The lubricant-coolant mixture selection method according to claim 1, wherein the determining of the respective coolant and lubricant concentrations comprises deriving the respective coolant and lubricant concentrations from suggested mixing ratios.

8. The lubricant-coolant mixture selection method according to claim 1, further comprising executing the metalworking based on determining results to apply the coolant-lubricant mixture to the metallic surface for the preventing of the thin-film lubricant rupture.

9. A lubricant-coolant mixture selection and application method for a metalworking of a metallic surface, comprising:
measuring surface roughness of the metallic surface;
generating data indicative of thin-film lubricant rupture conditions;
determining:
a lubricant film thickness for the metalworking based on the surface roughness and the data,
predictions of a chip formation pattern of the metalworking and where the chip formation pattern leads to chip impact on the metallic surface,
a heat generation prediction of the metalworking from tooling specifications and operational parameters, and
respective coolant and lubricant concentrations of a coolant-lubricant mixture of the metalworking from coolant and lubricant specifications; and
operating measuring, imaging and tooling components of a system for executing the metalworking based on determining results to apply the coolant-lubricant mixture to the metallic surface for preventing thin-film lubricant rupture.

10. The lubricant-coolant mixture selection and application method according to claim 9, wherein the measuring of the surface roughness comprises measuring average roughness, average peak-valley heights and root mean square roughness.

11. The lubricant-coolant mixture selection and application method according to claim 9, wherein the generating of the data comprises using machine learning to build a thin-film lubrication rupture predictive model.

12. The lubricant-coolant mixture selection and application method according to claim 9, wherein the determining of the lubricant film thickness comprises selecting a lubricant having viscosity, density and pressure-viscosity properties corresponding to the thickness.

13. The lubricant-coolant mixture selection and application method according to claim 9, wherein the determining of the predictions of the chip formation pattern and where the chip formation pattern leads to chip impact on the metallic surface comprises image analysis and pattern recognition.

14. The lubricant-coolant mixture selection and application method according to claim 9, wherein the determining of the heat generation prediction is based on calculations of a cutting energy and a volume of material to be removed of the metalworking.

15. The lubricant-coolant mixture selection and application method according to claim 9, wherein the determining of the respective coolant and lubricant concentrations comprises deriving the respective coolant and lubricant concentrations from suggested mixing ratios.

16. The lubricant-coolant mixture selection and application method according to claim 9, wherein:
the tooling components of the system for executing the metalworking comprise a coolant-lubricant dispenser, a mixing chamber upstream from the coolant-lubricant dispenser, a coolant tank, a first control valve interposed between the coolant tank and the mixing chamber, a lubricant tank and a second control valve interposed between the lubricant tank and the mixing chamber, and
the operating of the tooling components of the system for executing the metalworking comprises independently operating each of the first and second control valves.

17. The lubricant-coolant mixture selection and application method according to claim 16, wherein:
the measuring components of the system for executing the metalworking comprise robotic surface roughness measuring tools to generate profiles of the metallic surface,
the imaging components of the system for executing the metalworking comprise robotic imaging hardware to image the metalworking for support of the determining of the predictions of the chip formation pattern and where the chip formation pattern leads to chip impact on the metallic surface,
the tooling components of the system for executing the metalworking further comprise robotic metalworking tools,
the coolant-lubricant dispenser comprises a robotic dispenser, and
the robotic surface roughness measuring tools, the robotic imaging hardware, the robotic metalworking tools and the robotic dispenser are automatically and autonomously movable relative to the metallic surface.

18. A system for lubricant-coolant mixture selection and application for a metalworking of a metallic surface, comprising:
measuring, imaging and tooling components; and
a processor comprising memory and being configured to generate data in the memory indicative of thin-film lubricant rupture conditions and to operate the measuring, imaging and tooling components to:
measure surface roughness of the metallic surface;
determine:
a lubricant film thickness for the metalworking based on the surface roughness and the data,
predictions of a chip formation pattern of the metalworking and where the chip formation pattern leads to chip impact on the metallic surface,
a heat generation prediction of the metalworking from tooling specifications and operational parameters, and
respective coolant and lubricant concentrations of a coolant-lubricant mixture of the metalworking from coolant and lubricant specifications; and
execute the metalworking based on determining results to apply the coolant-lubricant mixture to the metallic surface for preventing thin-film lubricant rupture.

19. The system for lubricant-coolant mixture selection and application according to claim 18, wherein:
the tooling components comprise a coolant-lubricant dispenser, a mixing chamber upstream from the coolant-lubricant dispenser, a coolant tank, a first control valve interposed between the coolant tank and the mixing chamber, a lubricant tank and a second control valve interposed between the lubricant tank and the mixing chamber, and
operating the tooling components comprises independently operating each of the first and second control valves.

20. The system for lubricant-coolant mixture selection and application according to claim 18, wherein:
the measuring components comprise robotic surface roughness measuring tools to generate profiles of the metallic surface,
the imaging components comprise robotic imaging hardware to image the metalworking for supporting determining the predictions of the chip formation pattern and where the chip formation pattern leads to chip impact on the metallic surface,
the tooling components further comprise robotic metalworking tools,
the coolant-lubricant dispenser comprises a robotic dispenser, and
the robotic surface roughness measuring tools, the robotic imaging hardware, the robotic metalworking tools and the robotic dispenser are automatically and autonomously movable relative to the metallic surface.
